(19) United States
(12) Patent Application Publication
(10) Pub. No.: US 2006/0188684 A1
(43) Pub. Date: Aug. 24, 2006

(54) Optical recording medium, optical recording method and apparatus

(76) Inventor: Katsuyuki Yamada, Kanagawa-ken (JP)

Correspondence Address: COOPER & DUNHAM, LLP, 1185 AVENUE OF THE AMERICAS, NEW YORK, NY, 10036, US

(21) Appl. No.: 11/360,742

(22) Filed: Feb. 22, 2006

(30) Foreign Application Priority Data
Feb. 22, 2005 (JP) 2005-045971

(51) Int. Cl. B32B 3/02

(52) U.S. Cl. 428/64.4

(57) ABSTRACT

A number of novel optical recording methods, an optical recording apparatus configured to perform one or more of the optical recording method, and an optical recording medium configured for recording with one or more of the optical recording methods are provided. In one example, a plurality of optical recording pulse trains having at least a recording power Pw and a bias power Pb for recording a mark are prepared, and a number of pulses of the plurality of optical recording pulse trains are differentiated from each other. One of the plurality of optical recording pulse trains is selected in accordance with information related to an optical recordation speed, and a mark of a prescribed length is recorded on an optical recording medium allowing recording of a mark having a prescribed length not more than 0.7 μm, utilizing a selected one of the plurality of optical recording pulse trains.

### TECHNICAL FIELD

The present disclosure relates to an optical recording method, an optical recording apparatus, and an optical recording medium capable of recording information to a DVD-R disc, a DVD-RW disc, a DVD+R disc, a DVD+RW disc, a DVD-RAM disc, and Blu-ray disc, at high-speed while emitting a laser light. In particular, the present disclosure relates to an optical recording method, an optical recording apparatus, and an optical recording medium capable of recording information to a larger storage than a DVD-ROM disc with higher density. The present disclosure further relates to an optical recording method, an optical recording apparatus, and an optical recording medium having more than two multi layers capable of recording extremely large information.

### BACKGROUND ART

Generally, an optical recording medium is categorized into a once-recordation type and a rewritable type. The optical recording medium of the once-recordation type includes a substrate, a dye recording layer, and an optical reflection layer. The rewritable type optical recording medium includes a substrate, a bottom protection layer, an optical recording layer, a top protection layer, and an optical reflection layer. An intermediate layer is formed between the bottom protection layer and the optical recording layer, the optical recording layer and the top protection layer, or the top protection layer and the optical reflection layer as necessary. In order to more quickly record a large amount of information to the optical recording medium, it is expected that a new optical recording method and an optical recording medium are developed so as to record at higher speed with higher density. It is known that a high-speed recording technology records a mark having a length nT using n−1 number of emission light pulses.

To record information to a CD-RW disc at more than 24 times recording speed, a technology of recording two T mark with one pulse has been developed. Specifically, three T is recorded by one pulse, four and five Ts by two pulses, six and seven Ts by three pulses, eight and nine Ts by four pulses, ten and eleven Ts by five pulses. However, since such a light emission pattern for recording nT mark length is undifferentiated, it is difficult to form a recording mark at high speed with high density by utilizing conventional techniques. The conventional optical recording technology does not change a number of light emission pulses in accordance with various optical recording media, and, instead, adjusts any one of a light emission pulse width and light emission power. Such a technology practically enables recording to a CD disc and a DVD disc at 2.4 times recording speed at most. However, it is difficult to safely record a mark into various optical recording media at more than DVD four times recording speed with density similar to recording on a DVD disc.

There is a need for an improved optical recording technique.

### SUMMARY

The present disclosure provides novel optical recording methods.

In one example, an optical recording method includes the steps of preparing a plurality of optical recording pulse trains having at least a recording power Pw and a bottom power Pb for recording a mark, differentiating a number of pulses of the plurality of optical recording pulse trains from each other, providing an optical recording medium allowing recordation of a mark having a prescribed length not more than 0.7 μm, providing the optical recording medium with information related to an optical recording speed, selecting a prescribed one of the plurality of optical recording pulse trains in accordance with the information, and recording a mark of a prescribed length on the optical recording medium with a selected one of the plurality of optical recording pulse trains.

In another example, a time corresponding to the prescribed length of the mark is n times of a period T of a reference clock, wherein said n represents a natural number.

In another example, each of the number of pulses is one of n, n−1, n/2, (n−1)/2, and (n+1)/2 per length nT of the mark.

In another example, the number of pulses is small as a recording line speed is fast.

In another example, the number of pulses is small as the recording power Pw is small.

The present disclosure also provides an optical recording apparatus configured to perform one or more of the optical recording methods disclosed herein.

The present disclosure also provides an optical recording medium configured for recording with one or more of the optical recording methods disclosed herein.

### BRIEF DESCRIPTION OF DRAWINGS

A more complete appreciation of the present disclosure and many of the attendant advantages thereof will be readily obtained as the same becomes better understood by reference to the following detailed description when considered in connection with the accompanying drawings, wherein:

FIG. 1(a) illustrates an exemplary EFM signal of a pulse strategy using a two-T method;

FIG. 1(b) illustrates an exemplary optical recording pulse train of such a pulse strategy;

FIG. 1(c) illustrates an exemplary recordation mark of such a pulse strategy;

FIG. 2(a) illustrates an exemplary EFM signal of a pulse strategy using a one-T method;

FIG. 2(b) illustrates an exemplary optical recording pulse train of such a pulse strategy;

FIG. 2(c) illustrates an exemplary recordation mark of such a pulse strategy;

FIG. 3(a) illustrates an exemplary EFM signal in a pulse strategy constituted by a (n+1)/2 number of pulses in relation to a recordation mark length nT;

FIG. 3(b) illustrates an exemplary optical recording pulse train in a pulse strategy constituted by a (n+1)/2 number of pulses in relation to a recordation mark length nT;

FIG. 3(c) illustrates an exemplary recordation mark of a pulse strategy constituted by (n+1)/2 number of pulses for a recordation mark length nT;

FIG. 4 illustrates an exemplary recording medium and an exemplary optical recording apparatus;

FIG. 5 illustrates an exemplary DVD phase change type optical recording medium according to an example of the present disclosure; and

FIG. 6 illustrates an exemplary DVD double layer dye type optical recordation mark according to an example of the present disclosure.

### DETAILED DESCRIPTION OF PREFERRED EMBODIMENTS

Referring now to the drawings, wherein like reference numerals designate identical or corresponding parts throughout several views.

An optical recording medium of the present disclosure is capable of high density recording with the minimum recordation mark length of not more than 0.7 μm. Such an optical recording medium can be produced by adapting a method used for producing a conventional DVD medium. For example, a DVD+RW disc can be obtained such that a dielectric material layer, an optical recording layer, and a reflection layer are formed on a polycarbonate substrate having a thickness of 0.6 mm with a track pitch of 0.74 μm utilizing a sputtering method, and is laminated to another polycarbonate substrate having a thickness of 0.6 mm. A HD-RW disc can be obtained in the same manner as the DVD+RW disc except for using a polycarbonate substrate having a thickness of 0.6 mm with a track pitch of 0.4 μm. A BD-RE can be obtained such that a reflection layer, a dielectric material layer, and an optical recording layer are formed on a polycarbonate substrate having a thickness of 1.1 mm with a track pitch of 0.32 μm in a spattering method, while including a cover layer having a thickness of 0.1 mm formed by spin coating or another technique) on the side through which recordation or reproduction light enters. The minimum recordation mark length does not have a special lower limit and varies also in accordance with a wavelength of a laser light practically used. When a light source having 405 nm is employed, about 0.15 μm is the limit. Although the following explanation relates to eight times speed recordation to the DVD+RW disc, other high speed and high density optical recording media can be applied. When the eight times speed recordation is executed to the DVD+RW disc using a conventional recording method (i.e., a one-T method) in which a number of recording pulses increases by one as a mark length increases by one T, a ratio of rising and descending times of a pulse per an emission time of the pulse increases, and thereby a precise mark length can not be formed.

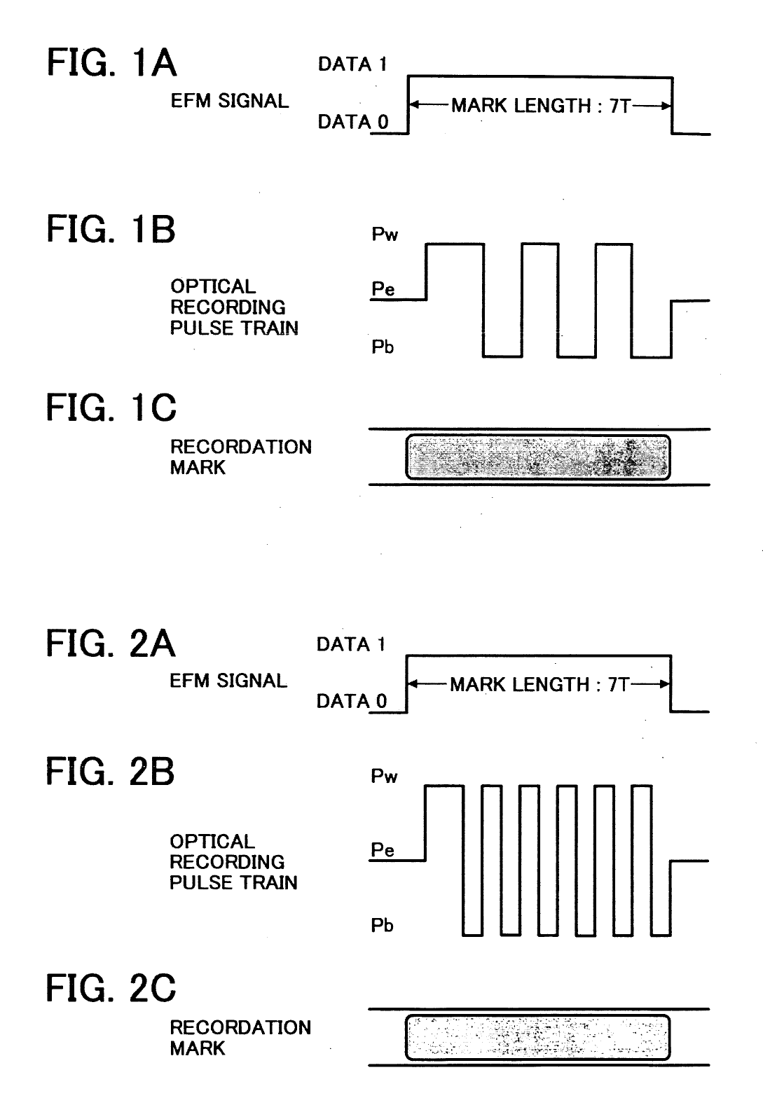

Further, the one T method necessitates large power for recordation, and sensitivity of the optical recording medium should be improved. Thus, a two-T method is proposed wherein a number of recording pulses increases by one as a mark length increases by two T as shown in FIG. 1. The two T method is advantageous in recording to an optical recording medium at high speed, but reliability of recordation is inferior to the one-T method. Especially, the two T method is difficult to apply to an optical recording medium with an unknown recording performance.

The present disclosure provides techniques for high speed and high density optical recording with certain reliability. For example, a plurality of light emission patterns (e.g. a pulse strategy, an optical recording pulse train, etc.) are prepared for a plurality of optical recordings in order to accommodate various optical recording media and record a prescribed mark length at high speed. Here, a difference in a light emission pulse pattern represents that of a number of pulses of an optical recording pulse string. For example, a plurality of pulse trains are prepared as shown in FIGS. 1 to 3, for example. Specific examples of pulse trains are discussed in U.S. Pat. Nos. 5,761,179, 5,732,062, 6,628,595, 6,631,109, 6,459,666, 6,741,547, and 6,757,232, or the like, the entire disclosure of each of which are incorporated by reference herein.

A criterion of selection is that a pulse train can steadily record on an optical recording medium and reduce recordation and reproduction errors. It can be selected such that a trial recording is executed using a plurality of previously prepared pulse trains, and a signal is reproduced and a quality is evaluated so as to select a pulse string that enables suppression of the error.

Specifically, it is determined whether the plurality of different number of pulses of the strategy can handle an optical recording medium when it is set in the optical recording apparatus and the ID or strategy information is then read therefrom. If the determination is negative, the above-mentioned test is executed so as to determine a suitable one of the plurality of different number of pulses. If the determination is positive, a prescribed one of the plurality of different number of pulses is utilized to execute the above-mentioned recording. Further, a selection criterion is not limited to the reproduction error, and possibly includes a reflection rate, a modulation level, and a jitter or the like.

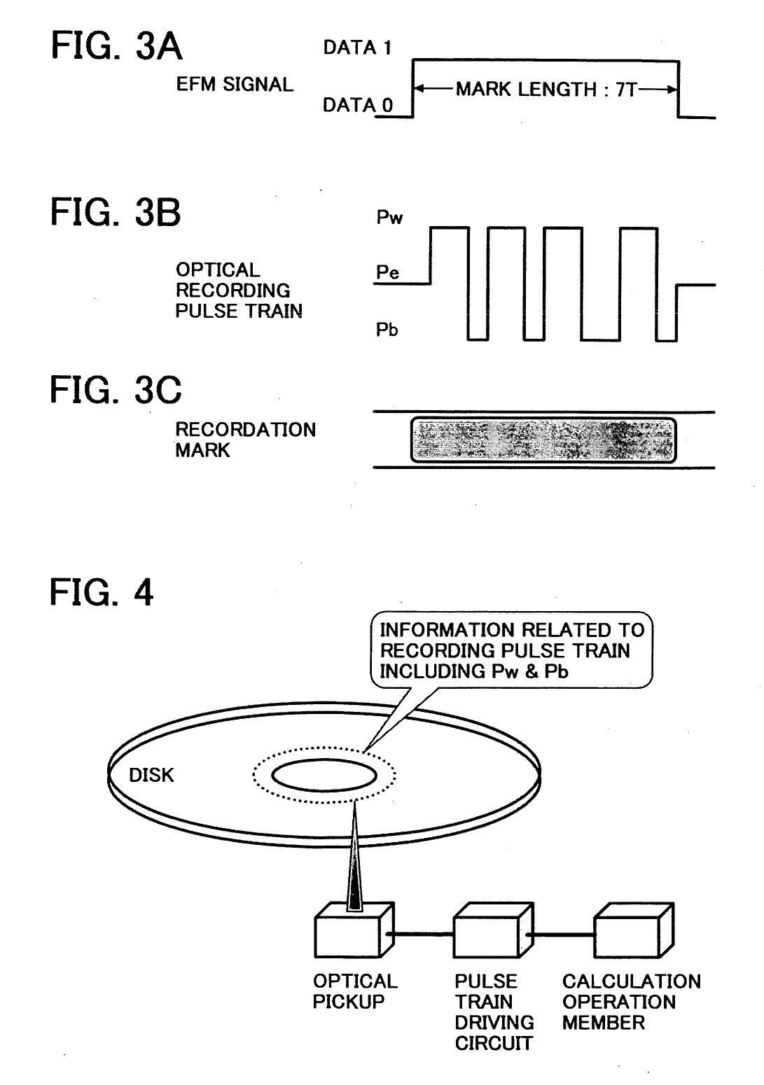

For example, it is effective to prepare the below described two types of light emission patterns for recording a mark length 7T. One of them is a recording pattern of a pulse strategy executed by the one T method as shown in FIG. 2. However, it slightly sacrifices high speed admitting some improvement in precision of a recordation mark length. The other is a light emission pulse pattern (i.e., a pulse strategy) constituted by (n+1)/2 number of pulses per recordation mark length nT as shown in FIG. 3. This pattern can maintain precision of the recordation mark length beside high speed. Then, a plurality of light emission patterns are prepared so as to record a mark length of 7T as mentioned below. Thus, preparation of the plurality of optical recording pulse train having different number of light emission pulses for an unknown optical recording medium is valid to improve reliability of an optical recording system. When the plurality of optical recording pulse trains having different number of light emission pulses are prepared, sensitivity of recording can be improved. Because, the less the number of pulses, the larger the effective power even with the same recording power. As a result, it is advantageous in high-speed recording, which generally tends to cause insufficient recording sensitivity. In short, configurations in which (i) the number of pulses is reduced as a recordation line speed is increased and/or (ii) the number of pulses is reduced as the recording power Pw is reduced are preferable.

It is effective to reproduce an ID of the optical recording medium, recognize a recording performance of the optical recording medium, and select a desired pulse string among the plurality of the optical recording pulse train already prepared by the optical recording apparatus. Further, it is also effective to perform test recording of an optical recording pulse train already prepared, and select based upon the result. Further, when the optical recording apparatus prepares some optical recording methods using different numbers of light emission pulses, it is effective for improving reliability of optical recording that an optical recording medium accommodates the optical recording methods using the different numbers of light emission pulses. Further, as shown in FIG. 4, since the optical recording apparatus can be provided with much information, it is effective for improving a reliability of the optical recording that the optical recording medium includes information related to the above-mentioned light emission patterns, various information formats, such as an information pit, a recordation mark, wobble modulation, etc., are available.

As an optical recording medium capable of accommodating the plurality of optical recording methods using different numbers of pulses, usage of an Ag based reflection film having crystalline substance as a reflection layer was effective. In order to accommodate the high speed and high density recording while avoiding heat generated by light recordation injection light from leaking in a direction of a plane of the optical recording medium, Ag or Ag alloy having large heat conductivity are effective. Further, it is effective to uniformly generate and cool heat in the plane that Ag particle is produced finer so that a crystal grain boundary of Ag does not affect thereof. As a method of producing finer Ag particle, it is important to form a film while presenting foreign substance to avoid coagulation of Ag. Specifically, an Ag particle diameter can be minimized by controlling a frequency of entrance of Ag atom or cluster, and the other atom, molecule, ion, or cluster, and soon, into the film surface in a light reflection film formation process. More specifically, it is effective to increase a frequency of entering coexisting gas into the film surface while increasing quantity of flow of coexisting gas (e.g. Ar, N2, O2) during spatter film formation. It is also effective to form a film by decreasing an evacuation speed while increasing film formation pressure, and increases a frequency of entering the coexisting gas into the film surface. Further, as a method of decreasing a frequency of entering Ag into the film surface, it is effective to decrease film formation spatter power so as to decrease a film formation speed. Further, it is effective to decrease temperature of a substrate when an Ag based light reflection film is formed. When a film is practically formed, a size of the Ag particle can be controlled by adjusting these conditions.

In order to effectively produce finer Ag particle, it is effective to form a film under presence of foreign substance, such as Mg, Al, Si, Ca, Ti, Cr, Cu, Zn, Y, Ce, Nd, Gd, Tb, Dy, Nb, Mo, Pd, In, Sn, Ta, W, Pt, etc. When the Ag particle grows, a portion constituting a grain boundary includes lots of these additives. Accordingly, the Ag particle can be finer due to these additives. Selection of a type among these metals and an additional amount thereof are affected by a spatter condition of the Ag based light reflection film. The more the additives, the easily finer the Ag particle. However, high reflectivity and high heat conductivity expected to the Ag as physicality is spoiled. When an amount of the additives decreases, the physicality expected to the Ag is maintained. However, a film formation condition needs strict controlling. A type of the additives is affected by a condition of forming the Ag based light reflection film. When Cu, Pd, or Pt easily mixed with Ag to produce alloy is used, Ag can be produced finer while maintaining the physicality. However, it is important to control a film formation condition to produce finer particle diameter because of such a tendency of easy mixture with the Ag to produce alloy. When an additional amount of Mg, Al, Si, Ca, Ti, Cr, Zn, Nb, Mo, In, Sn, Ta, W, etc. is large, the physicality of the Ag is spoiled. However, those effectively work in forming the grain boundary due to easy attraction of the coexisting gas when a film is formed. Thus, those suppress progress of enlargement of the Ag crystal particle, and are effectively make the Ag crystal particle finer. Further, additive, such as Y, Ce, Nd, Gd, Tb, Dy, Zr, Hr, In, Sn, etc., has a larger atom diameter than that of the Ag. Thus, they can suppress progress of crystallization of the Ag particle, and produce finer crystal particle diameter of the Ag.

It was determined that influence of a grain boundary noise of an Ag based light reflection film to a recordation or reproduction signal is effectively neglected when the noise is not more than ⅓ of the least recordation mark. As a result of considering this point of view from the experience of the inventor, it is known that ⅓ of the least recordation mark corresponds to a channel bit of a mark to be recorded. The channel pit represents the least unit corresponding to information “0” and “1” used at the time of optical recording, and corresponds to 0.133 μm in case of a DVD-ROM disc. Specifically, in cases of DVD-R, DVD-RW, DVD+R, and DVD+RW, an average length Lag of crystal particle is effective if it is not more than one bit length Lbi (i.e., 0.133 μm) of the mark. A size of the crystal particle of the Ag based light reflection layer is preferably not more than a channel bit length, preferably not more than ⅔ of the channel bit length, considering evenness of the crystal particle diameter.

Further, when a guide groove included in the optical recording medium is snaked, it is important that the particle diameter is sufficiently smaller than that of a cycle of the snaking (wobble).

The optical recording apparatus needs to precisely read snaking of the guide groove of the optical recording medium. However, when the optical recording apparatus reads a grain boundary of Ag particle, an address of the optical recording medium can't be precisely read. Especially, in the optical recording medium such as a DVD disc, a DVD-R disc, a DVD-RW disc, etc., including a guide groove having a pit, reading becomes more difficult. In view of a relation between a crystal particle diameter of an Ag based light reflection film and a wobble of the guide groove, the Ag crystal particle diameter is preferably not more than 1/10 of one snaking cycle. Because, snaking information can be complemented even if a noise enters into a 1/10 portion during one snaking. More preferably, the Ag crystal particle diameter is not more than 1/20 of one snaking cycle. Because, snaking information can neglect a noise even if the noise enters into a 1/20 portion during one snaking. Further, the Ag crystal particle diameter is preferably not more than 1/10 and more preferably 1/20 of a pit interval when the pit is included.

From the experiment of the inventor, it has been known that moisture attracted to the substrate surface affects an adhesion force between an Ag based light reflection layer and a layer on which the Ag based light reflection layer is formed by a certain degree. It is also known that improvement of passivation ability of an intermediate layer on which the Ag based light reflection layer is formed causes improvement of an adhesion force between the Ag based light reflection layer and the intermediate layer. The inventor considers that it is effective if an intermediate layer includes the below described substance in order to effectively maintain an adhesion force to the Ag based light reflection layer and have passivation ability for preventing a reaction between the Ag and the later mentioned ZnS and SiO2. Specifically, it is a first substance that is capable of creating invasion type compound with atom packing being dense for the purpose of maintaining passivation ability. It is another substance that is capable of maintaining a wet performance between the Ag based light reflection layer and the intermediate layer so as to maintain an adhesion force. Then, a carbide target such as Ti, Zr, Ta etc., capable of creating an invasion type compound is considered so as to maintain passivation ability. Also, an intermediate layer formed from a target including these metal oxides is considered so as to maintain a wet performance of the Ag based light reflection layer.

A layer configuration of an optical recording medium considered includes a guide groove attached information substrate, a bottom protection layer, a boundary face layer, an optical recording layer, a top protection layer, an intermediate layer, an optical recording layer, a ultra violet light curable resin, an adhesion layer, and a cover substrate. As a substrate with guide groove bearing information, a polycarbonate substrate having thickness of 0.6 mm, a groove width of 0.25 μm, a groove depth of 27 nm, and a wobble groove having a cycle of 4.26 μm can be prepared using injection molding. The bottom protection layer, the boundary face layer, the optical recording layer, the top protection layer, the intermediate layer, and the optical reflection layer can be laminated one after another using a spattering method. The bottom protection layer, the boundary face layer, and top protection layer can be produced by a RF-spattering method. The optical recording layer, the light reflection layer can be produced by a DC spattering method.

(ZnS)₈₀(SiO₂)₂₀ (molecule %) having a thickness of 55 nm can be included in the bottom protection layer. SiO₂ having a thickness of 4 nm can be included in the boundary face layer. Ge₈Ga₆Sb₆₈Sn₁₈ having a thickness of 11 nm can be included in the optical recording layer. (ZnS)₈₀(SiO₂)₂₀ (mole %) having a thickness of 11 nm can be included in the top protection layer. Pure silver having a thickness of 140 nm can be included in the light reflection layer. The intermediate layer can have a thickness of 6 nm and can be produced by apply the DC or RF-spattering to a sinter target including carbide and oxide. SiC, TiC, ZrC, NbC, and TaC can be considered for the carbide. SiO₂, TiO₂, ZrO₂, Nb₂O₅, and Ta₂O₅ can be considered for the oxide. Then, a resin protection layer can be formed on the optical reflection layer by applying spin coating with ultra violet light curable type resin (Dainippon Ink and Chemicals, Incorporated) that has viscosity of 120 cps in an atmosphere and glass transition temperature 149° C. after curing, thereby a single plate disc of a phase change type optical recording medium can be formed. In the above, light exposure can be 80% of that required.

Then, a laminating substrate made of polycarbonate can be laminated with ultra violet light curable type adhesive (Nippon Kayaku Co., Ltd. DVD003) that has viscosity of 450 cps in an atmosphere and glass transition temperature 75° C. after curing, thereby a phase change type optical recording medium (i.e., an optical disc) is formed. In the above, light exposure can be 80% of that required.

Then, using an initializing apparatus manufactured by Hitachi Computer Peripherals Co., Ltd having a large caliber LD (e.g. a beam diameter: 75 μm×1 μm), surface crystallization is performed to the optical recording layer from inner to outer peripheries thereof at a constant line speed that is 70% of the maximum recording line speed for the optical disc with power of 1600 mW at a feeding rate of 45 μm/r.

The manufacture change durability of the above-mentioned optical disc is evaluated with regard to the below described matters. First, a DC spatter possibility is evaluated. Second, air-leakage proof at the time of forming a film of an intermediate layer is evaluated. Third, an initialization resistance is evaluated. The following matters are used as respective durability evaluation process conditions. A first condition is possibility of film formation by a DC spatter. A second condition is presence of error occurring when a signal is optically recorded into an optical disc having an intermediate layer manufactured by an air leakage of 1E⁻⁴ mbar and is preserved for 24 hours with conditions of 80° C. 85% RH (e.g. NG, when a PI error-increasing rate is 50%). A third condition is a failure rate of an optical disc initialized after accelerated deterioration for 24 hours with conditions of 80° C. 85% RH (e.g. NG, when more than 1E⁻⁴). A groove reflection rate (%) and sensitivity (e.g. a recording power, (mW)) obtained when a recording power causing the least jitter after recordation are used as recording performances of the optical disc.

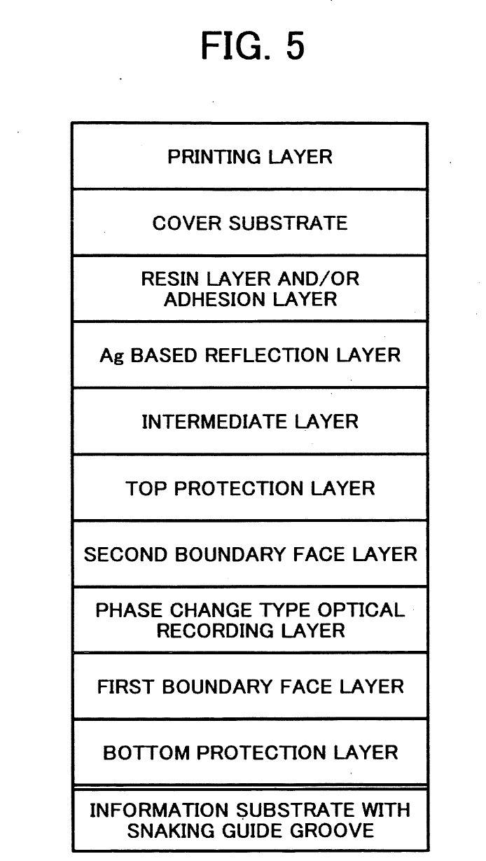

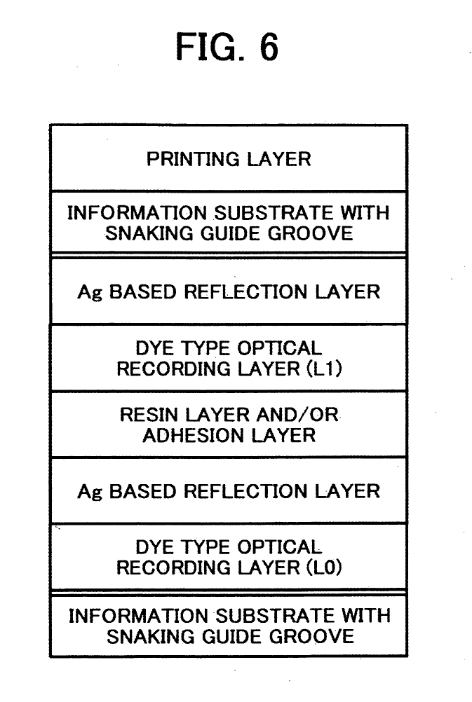

FIG. 5 illustrates one example of a DVD type phase change type optical recording medium according to an example of the present disclosure. The DVD phase change type recordation mark includes a bottom protection layer, a phase change type optical recording layer, a top protection layer, and an Ag based reflection layer, a resin layer and/or an adhesive layer, and a cover substrate respectively formed in this order on a snaking guide groove attached information substrate. In order to improve a performance, first and second boundary face layers, and an intermediate layer are formed as necessary. Further, a printing layer can be arranged on the cover substrate. Further, a similar phase change type optical recording medium can be arranged on a cover substrate side in a reverse order to form a double layer type. FIG. 6 illustrates one example of a DVD layer dye type optical recording medium according to the present disclosure. As shown, a dye type optical recording layer (LO), an Ag based reflection layer, and a resin layer are formed on the snaking guide groove attach information substrate, while an Ag based reflection layer and a dye type optical recording layer (L1) are formed and laminated in a reverse layer state on the other snaking guide groove attach information substrate. Further, a printing layer can be arranged on the cover substrate. However, the present disclosure is not limited to these layer configurations and can be applied to various optical recording media.

Material of the substrate includes normal glass, ceramics, or resin. A resin substrate is preferable in view of a molding performance and cost. As examples of the resin, polycarbonate resins, acrylic resins, epoxy resins, polystyrene resins, acrylonitrile-styrene copolymers, polyethylene resins. Among those, the polycarbonate resins or the acrylic resins are preferable in view of a molding performance, an optical performance, and cost. However, when an optical recording medium of the present disclosure is applied to DVD+R, the below described specific conditions are preferably met. Specifically, a width of the guide groove formed on the substrate ranges from 0.01 μm to 0.40 μm, preferably from 0.15 μm to 0.35 μm. The depth of the guide groove ranges from 120 to 200 nm, and preferably 140 to 180 nm. A cycle of snaking of the guide groove is 4.3 μm. The thickness of the substrate preferably ranges from 0.55 to 0.65 mm. The thickness of the disc after laminating preferably ranges from 1.1 to 1.3 mm.

With such a substrate groove, reproduction compatibility is improved in a DVD-ROM drive. Further, when the optical recording medium of the present disclosure is applied to DVD+RW, the below described specific conditions are preferably met. Specifically, a width of the guide groove formed on the substrate ranges from 0.01 μm to 0.40 μm, preferably from 0.15 μm to 0.35 μm. The depth of the guide groove ranges from 15 to 45 nm, and preferably 20 to 40 nm. A cycle of snaking of the guide groove is 4.3 μm. The thickness of the substrate preferably ranges from 0.55 to 0.65 mm. The thickness of the disc after laminating preferably ranges from 1.1 to 1.3 mm. With such a substrate groove, reproduction compatibility is improved in the DVD-ROM drive.

Oxide such as SiO, SiO₂, ZnO, SnO₂, Al₂O₃, TiO₂, In₂O₃, MgO, ZrO₂, etc., nitride such as Si₃N₄, AlN, TiN, BN, ZrN, etc., Sulfide such as ZnS, TaS₄, etc., diamond state carbon and mixture of those are exemplified as material of the bottom and the top protection layers of the phase change type optical recording medium. Among those, substance including SiO2 and ZnS, such as (ZnS)₈₅(SiO₂)₁₅, (ZnS)₈₀(SiO₂)₂₀, (ZnS)₇₅(SiO₂)₂₅ (each mole %), etc., are preferable. Especially, as the bottom protection layer located between the phase change type optical recording layer, which causes heat inflation change and receives heat damage when temperature is high and atmosphere changes, and the substrate, (ZnS)₈₀(SiO₂)₂₀ (mole %) having an optimized optical constant, a heat inflation coefficient, and an elastic modulus, is most preferable. The thickness of a film of the bottom protection layer is preferably a level so as to cause a disc reflection rate to be minimum in relation to a film thickness of the bottom protection layer, because the thickness of the bottom protection layer largely affects the reflection rate, a modulation degree, and recording sensitivity. Within this film thickness range, the recording sensitivity is excellent, recordation can be achieved with less power without heat damage, and an overwrite performance can be improved. When (ZnS)₈₀(SiO₂)₂₀ (mole %) is employed in the bottom protection layer and thinner than 45 nm to obtain an excellent signal performance in a DVD recordation or reproduction wave length, the substrate is largely damaged by heat, and the groove deforms. Further, when it is thicker than 65 nm, a disc reflection rate increases and sensitivity decreases.

Further, as a sulfur free top protection layer of the phase change type optical recording medium, material, such as zinc oxide, indium oxide, tin oxide, niobium oxide, silicon nitride, aluminum nitride, ZnS, etc., which effectively suppresses crack, having a spatter speed preferable for manufacturing the optical recording medium, are exemplified.

In some of the examples of the present disclosure, these preferable materials are used as a main component that exceeds 50 mole %. The materials used preferably receives addition of oxide of Si, Al, Ti, Zn, Zr, Mo, Ta, Nb, and W, capable of networking with oxide, which has excellent combination rotation freedom degree of divalent, in view of flexibility of a film. However, when the film of the top protection layer material of these is formed thick, crack tends to occur due to interior stress of the film or heat stress between the optical recording layer and the Ag or Ag alloy reflection layer. Further, by making the top protection layer into multi layers, and thereby forming a boundary face of the top protection layer, as well as making a heat storage configuration while preventing heat conduction, heat sensitivity of the optical recording can be improved.

Accordingly, a thickness of the top protection layer is preferably 4 to 24 nm. Specifically, if it is less than 4 nm, the heat storage function of the top protection layer insufficiently works, and recording with an existing semiconductor laser becomes difficult. In contrast, if it becomes thicker than 24 nm, the crack occurs as mentioned above. A more preferable film thickness of the top protection layer is from 8 to 20 nm.

Further, a phase change type optical recording medium is manufactured by continuous film formation of a bottom protection layer, an optical recording layer, a top protection layer, and an optical reflection layer using spattering. Here, the layer to need longest time for film manufacturing is the bottom protection layer or the optical reflection layer having thicker film than the others. Accordingly, in order to efficiently form the top protection layer, a film formation condition for the top protection layer is preferable if the condition allows formation of a prescribed thickness of the top protection layer within the same or shorter manufacturing time when formation of the bottom protection layer or the optical reflection layer is achieved. When ZnS/SiO₂ is used as the bottom protection layer, Ag or Ag alloy is used as the reflection layer, and a spatter time is aimed to be less than seven seconds, a film formation speed of the top protection layer needs to be at least 1 nm/s, preferably needs not less than 3 nm/s. When a film is formed as thinner as possible to have a thickness of 4 to 24 nm, and a film formation speed is too fast, a rising time for generating plasma largely occupies a spattering film formation process. As a result, unevenness of the film thickness becomes large per disc, and sensitivity of the disc performance largely varies. In order to reduce the unevenness of the film thickness of the top protection layer per disc, a limit film formation speed is not more than 10 nm/s, and preferably not more than 8 nm/s.

Further, to maintain an initial condition, especially a power margin, in a manufacturing process of the phase change type optical recording medium, it was effective that binding of Ag—O is formed on a boundary between the top protection layer and an optical reflection layer having Ag or Ag alloy as a main component. The Ag—O binding is confirmed in an analysis method, such as XPS, etc. When AlN, and Si₃N₄ are utilized as a top protection layer, since oxide is supplied from evacuated gas or remaining gas from the substrate, formation of the Ag—O binding was confirmed. However, an amount of the Ag—O binding tends to be relatively small, and the power margin decreases when the initialization is executed in comparison with a case when the oxide is used as the top protection layer.

Material of the phase change type optical recording layer is preferable if including Sb by an amount of 60 to 90-atom %. As specific examples, InSb, GaSb, GeSb, GeSbSn, GaGeSb, GeSbTe, GaGeSbDn, AgInSbTe, GeInSbTe, GeGaSbTe, and similar material including 3Sb by an amount of 60 to 90 atom % are exemplified.

When a DVD+RW medium is manufactured from these phase change substance, and based on a relation between a Sb composition ratio and a time when the minimum recordation mark, which enables DVD compatibility or CD compatibility, can be recorded, it has been known that a recording time can be decreased when an amount of Sb of a recording layer is not less than 60-atom %. Specifically, a melting time of the optical recording layer can be decreased when recording erase is executed, and heat damage on the optical recording layer and the top protection layer can be reduced. Further, when the amount of Sb is not less than 60 atom %, the heat damage can be reduced. Because, melt initial crystallization of the optical recording medium can be executed at high speed. Further, when an amount of Sb is not less than 70 atom %, the heat damage can be reduced. Because, the initialization line speed can be not less than 10 m/s. However, when the Sb exceeds 90 atom %, it is undesirable because of deterioration in high temperature and high humidity of the mark even if various elements are added. A thickness of the phase change type optical recording layer is preferably from 8 to 14 nm. Further, when the thickness is not more than 8 nm, a problem is caused in life, because the crystallization of the recordation mark is quickly promoted under high temperature and high humidity of 80° C. 85% RH. When the thickness exceeds 14 nm, large quantity of heat is generated, damage on the top protection layer is serious, and cracking is triggered on the top protection layer, when the optical recording erase is executed.

As a manufacturing method for manufacturing an optical reflection layer including a bottom protection layer, an optical recording layer, a top protection layer, and Ag or Ag alloy of the phase change type optical recording medium, a plasma CVD, a plasma processing, an ion plating, an optical CVD, and similar devices can be utilized. However, spatter generally used in manufacturing the optical recording medium is preferable.

Typical manufacturing conditions of the manufacturing method are 10⁻² to 10⁻⁴ mbar of pressure, 0.1 to 5.0 kw/200 mm φ of spatter power, and 0.1 to 50 nm/s of film formation speed. As a dye recording layer, conventional cyanine dyes, azo dyes, phthalocyanine dyes, squarilium dyes or the like are utilized. As a matching with Ag optical recording medium, an element is effectively selected from Ti, Zr, Hr, V, Nb, Ta, Cr, Mo, and W when a metal complex is used.

As a resin protection layer, a ultraviolet light curable type resin produced in a spin coat method is preferable. The thickness of the resin protection layer is preferably 3 μm to 15 μm. When the thickness is not more than 3 μm, a printing layer is sometimes increasingly erroneously formed on the over coat layer. In contrast, when the thickness is not less than 15 μm, an interior stress increases and largely affects a machine performance of a disc. When a barcode layer is arranged, an ultraviolet light curable type resin produced in a spin coat method is typically used. The thickness thereof is 2 μm to 6 μm. When the thickness is not more than 2 μm, an abrasion proof performance is insufficient. When the thickness is not less than 6 μm, an interior stress increases and largely affects a machine performance of a disc. Hardness needs to be more than pencil hardness H so that a large cut is not created even if being rubbed by cloth. It is effective to avoid charging, accordingly dust or the like from sticking by blending conductive material upon need. The printing layer aims to maintain an abrasion performance, print a label of a bland name, form an ink reception layer in relation to an ink jet printer. The printing layer is thus preferably made of ultraviolet light curable type resin using a screen printing method. The thickness is preferably 3 μm to 50 μm. When the thickness is not more than 3 μm, a layer is unevenly formed. In contrast, when the thickness is not less than 50 μm, an interior stress increases and largely affects a machine performance of a disc.

As an adhesive layer, an ultraviolet light curable type resin, a hot melt adhesive, silicone resin, and similar material can be employed. These material are coated on the over coat layer or the printing layer using a spin coat, a roll coat, or a screen printing method in accordance with the material. Then, these are then laminated to a disc of the opposite side surface while receiving irradiation of an ultraviolet light, heat, and pressure or the like. The disc of the opposite side surface can be any one of a similar single plate disc and only a transparent substrate. The laminating surface of the opposite side surface disc is preferably coated or not coated with material of the adhesive layer. As the adhesive layer, a sticking sheet can be utilized. A film thickness of the adhesive layer is not limited. However, when considering influence to a material coating performance, curability, and a machine performance of a disc, the film thickness is preferably 5 μm to 100 μm, and preferably 7 μm to 80 μm. An area of the adhesive surface is not limited. However, when a DVD and/or a rewritable disc capable of executing CD transposition are used, and recording is performed at high speed, a position of an end of an inner periphery is 15 to 40 mmφ, preferably 15 to 30 mmφ, in order to enable high speed recording and ensure adhesion force.

An optical recording method, according to one example of this disclosure, includes (a) preparing a plurality of optical recording pulse trains having at least a recording power Pw and a bias power Pb, (b) differentiating a number of pulses of the plurality of optical recording pulse trains from each other, (c) selecting one of the plurality of optical recording pulse trains in accordance with information related to an optical recording speed, and (d) recording a mark on an optical recording medium allowing recordation of a mark having a prescribed length not more than 0.7 μm, utilizing the selected one of the plurality of optical recording pulse trains.

An optical recording apparatus may be configured with processing means and recording means to perform the optical recording methods disclosed herein. The recording means can be one or a combination of the mechanisms utilized in conventional optical recording apparatuses for recording a mark on an optical recording medium. The processing means can be configured through appropriate programming to perform, for example, (a)-(c) above. As another example, the optical recording apparatus can include the components shown in FIG. 4 or in U.S. Pat. Nos. 5,761,179, 5,732,062, 6,628,595, 6,631,109, 6,459,666, 6,741,547 and 6,757,232 (the entire disclosure of each of which are incorporated by reference herein), or the like.

In another example, the optical recording apparatus may be configured to perform the following optical recording method: (i) preparing a plurality of optical recording pulse trains having at least a recording power Pw and a bias power Pb, (ii) retrieving information regarding a preferred pulse strategy from an optical recording medium allowing recordation of a mark having a prescribed length not more than 0.7 μm, (iii) selecting one of the plurality of optical recording pulse trains in accordance with the retrieved information regarding preferred pulse strategy, and (iv) recording a mark on the optical recording medium utilizing the selected one of the plurality of optical recording pulse trains.

### EXAMPLES

Herein below, several additional examples of the present disclosure are described, but the present disclosure is not limited thereto.

First example is now described. A polycarbonate substrate is produced by injection molding to have a thickness of 0.6 mm with a guide groove having a width of 0.25 μm, a depth of 27 nm, and a wobble frequency of 4.26 μm. The polycarbonate substrate is left in an atmosphere for 10 minutes. A plurality of layers of a bottom protection layer, a boundary face layer, a phase change type optical recording layer, a top protection layer, an intermediate layer, and an optical recording layer are laminated on the polycarbonate substrate one after another in a spattering method.

In an internal periphery of the substrate, pulse numbers of (n−1)/2 and n/2 are recorded in a method of wobble phase modulation per recording of a mark length of nT as a recommended recording strategy.

(ZnS)₈₀(SiO₂)₂₀ (mole %) is used in the bottom protection layer which has a thickness of 55 nm. SiO₂ is included in the boundary face layer which has a thickness of 4 nm. Ge₈Ga₆Sb₆₈Sn₁₈ is used in the phase change type optical recording layer which has a thickness of 11 nm. (ZnS)₈₀(SiO₂)₂₀ (mole %) is utilized in the top protection layer which has a thickness of 8 nm. Ti₄₄C₂₆O₃₀ is utilized in the intermediate layer which has a thickness of 6 nm. Ag having Cu-0.5 weight % and purity of 99.5 weight % is employed in the optical reflection layer which has a thickness of 140 nm. As a result, a layer configuration is formed by including a carbonate substrate, (ZnS)₈₀(SiO₂)₂₀ (mole %) of 52 nm, SiO2 of 4 nm, Ge₈Ga₆Sb₆₈Sn₁₈ of 11 nm, (ZnS)₈₀(SiO₂)₂₀ (mole %) of 8 nm, Ti₄₄C₂₆O₃₀ of 4 nm, and Ag having a thickness of 140 nm, Cu-0.5 weight %, and purity of 99.5 weight %.

An Ag—Cu reflection layer is produced by spattering of nitride 5%-Ar so as to suppress increase in diameter of Ag particle as much as possible. Then, spin coating is executed with a ultraviolet light curable type resin (manufactured by Dainippon Ink and Chemicals, Incorporated, SD318) that becomes to have atmosphere temperature viscosity of 120 cps and glass transition temperature 149° C. after curing on the optical reflection layer so as to form a resin protection layer. Thereby, a single plate disc of the phase change type optical recording medium is produced. A laminating substrate made of polycarbonate is laminated with a ultraviolet light curable type resin (manufactured by Nippon Kayaku, Co., Ltd, DVD003) that becomes to have atmosphere temperature viscosity of 450 cps and glass transition temperature 75° C. after curing, thereby a phase change type optical recording medium is obtained. Further, it is left in the 80° C. 80% RH for 24 hours.

An initializing apparatus manufactured by Hitachi Computer Peripherals Co., Ltd, having a large caliber LD (e.g. a beam diameter: 75 μm×1 μm) applies crystallization to the optical recording layer from inner to outer peripheries thereof at a constant line speed of 20 m/s with power of 1600 mW at a feeding rate of 45 μm/r.

An optical recording apparatus of the present disclosure prepares two types of optical recording pulse trains having (n−1)/2 and (n−1) number of pulses. The optical recording apparatus is adjusted to recognize the optical recording medium as unknown medium. From confirmation of an operation executed when the above-mentioned optical recording medium is set to the above-mentioned optical recording apparatus on conditions that recording power Pw is 20 mW and a bias power Pb is 0.1 mW, the optical recording medium is recognized as an unknown medium. Further, a recording operation is stably executed with (n−1) number of pulses without error when the recording line speed is decreased down to 14 m/s. The least recording mark length was 0.4 μm.

Another example is now described. An optical recording medium and an optical recording apparatus each having substantially the same configuration as those in the first example are employed. The optical recording medium includes information that represents that pulse trains suitable for recording are (n−1)/2 and n/2. From confirmation of an operation executed when the above-mentioned optical recording medium is set to the above-mentioned optical recording apparatus on conditions that recording power Pw is 35 mW, and a bias power Pb is 0.1 mW, the optical recording medium is recognized as a known medium. Further, a high-speed recording can be more stably executed with (n−1)/2 number of pulses without error when the recording line speed is 28 m/s. The least recordation mark length was 0.4 μm.

Numerous additional modifications and variations of the present disclosure are possible in light of the above teachings. It is therefore to be understood that within the scope of the appended claims, the subject matter of the present disclosure may be practiced otherwise that as specifically described herein. For example, elements and/or features of different examples and illustrative embodiments may be combined with each other and/or substituted for each other within the scope of this disclosure and appended claims.

This application claims priority under 35 U.S.C. §119 to Japanese Patent Application No. 2005-045971, filed Feb. 22, 2005, the entire contents of which are herein incorporated by reference.

What is claimed is:

1. An optical recording method, comprising the steps of:
preparing a plurality of optical recording pulse trains having at least a recording power Pw and a bias power Pb;
differentiating a number of pulses of the plurality of optical recording pulse trains from each other;
selecting one of the plurality of optical recording pulse trains in accordance with information related to an optical recording speed; and
recording a mark on an optical recording medium allowing recordation of a mark having a prescribed length not more than 0.7 μm, utilizing the selected one of the plurality of optical recording pulse trains.

2. The optical recording method according to claim 1, wherein a time corresponding to said prescribed length of the mark is n times of a period T of a reference clock, wherein said n represents a natural number.

3. The optical recording method according to claim 2, wherein each of said number of pulses is one of n, n−1, n/2, (n−1)/2, and (n+1)/2 per length nT of the mark.

4. The optical recording method according to claim 3, wherein the number of pulses is reduced as a recordation line speed is increased.

5. The optical recording method according to claim 4, wherein the number of pulses is reduced as the recording power Pw is reduced.

6. An optical recording method comprising:
preparing a plurality of optical recording pulse trains having at least a recording power Pw and a bias power Pb;
retrieving information regarding a preferred pulse strategy from an optical recording medium allowing recordation of a mark having a prescribed length not more than 0.7 μm;
selecting one of the plurality of optical recording pulse trains in accordance with the retrieved information regarding preferred pulse strategy; and
recording a mark on the optical recording medium utilizing the selected one of the plurality of optical recording pulse trains.

7. The optical recording method according to claim 6,
wherein a time corresponding to said prescribed length of the mark is n times of a period T of a reference clock, said n represents a natural number, and the preferred pulse strategy provides that each of said number of pulses is one of n, n−1, n/2, (n−1)/2, and (n+1)/2 per length nT of the mark.

8. An optical recording apparatus configure to perform the optical recording method of claim 1.

9. An optical recording apparatus configure to perform the optical recording method of claim 6.

10. An optical recording apparatus comprising:
processing means for preparing a plurality of optical recording pulse trains having at least a recording power Pw and a bias power Pb, differentiating a number of pulses of the plurality of optical recording pulse trains from each other, and selecting one of the plurality of optical recording pulse trains in accordance with information related to an optical recording speed; and
recording means for recording a mark on an optical recording medium allowing recordation of a mark having a prescribed length not more than 0.7 μm, utilizing the selected one of the plurality of optical recording pulse trains.

11. An optical recording medium configured for recording with the optical recording method of claim 1.

12. The optical recording medium according to claim 11, wherein a time corresponding to said prescribed length of the mark is n times of a period T of a reference clock, said n represents a natural number, and each of said number of pulses is one of n, n−1, n/2, (n−1)/2, and (n+1)/2 per length nT of the mark.

13. The optical recording medium according to claim 11, wherein information related to the plural number of pulses is stored on the optical recording medium.

14. An optical recording medium configured for recording with the optical recording method of claim 6.
